(19) United States
(12) Patent Application Publication
(10) Pub. No.: US 2017/0052807 A1
(43) Pub. Date: Feb. 23, 2017

(54) METHODS, APPARATUSES, AND COMPUTER PROGRAM PRODUCTS FOR DEPLOYING AND MANAGING SOFTWARE CONTAINERS

(71) Applicant: TELEFONAKTIEBOLAGET LM ERICSSON (PUBL), Stockholm (SE)

(72) Inventors: Johan KRISTIANSSON, LULEÅ (SE); Nicklas SANDGREN, LULEÅ (SE)

(73) Assignee: TELEFONAKTIEBOLAGET LM ERICSSON (PUBL), Stockholm (SE)

(21) Appl. No.: 15/118,638

(22) PCT Filed: Feb. 20, 2014
(86) PCT No.: PCT/SE2014/050211

§ 371 Date: Aug. 12, 2016

(51) Int. Cl. G06F 9/455; G06F 9/445

(52) U.S. Cl. CPC G06F 9/45558; G06F 8/60; G06F 2009/45595

(57) ABSTRACT

A method, system, and computer program product is provided for deploying software containers by a container engine manager, CEM. The CEM instantiates a first container engine and instantiates a second container engine. The CEM determines that a first software container utilizing a first port number should be deployed. In response to determining that the first software container should be deployed, the CEM selects a container engine from a set of available container engines. The set of container engines comprises the first container engine and the second container engine. The CEM then causes the selected container engine to instantiate the first software container. The CEM associates the first port number with an IP address of the selected container engine.

### TECHNICAL FIELD

This disclosure relates to apparatuses, methods and computer program products for deploying software containers.

### BACKGROUND

Cloud computing facilitates the deployment of web-based services, such as an e-mail hosting service or webpage hosting service. In some cloud computing environments, a data center such as an Amazon EC2 data center or an OpenStack-based data center provides an

Infrastructure-as-a-Service (IaaS) system that allows a user to dynamically create virtual machines that can run an e-mail hosting application, web hosting application, or other software. See e.g., www.webopedia.com/TERM/HaaS.html. The virtual machines provide hardware virtualization that emulates processing, storage, and/or network resources for hosting such services.

Some providers of cloud computing platforms provide a suite of software components (e.g., Google App Engine, OpenShift, and CloudFoundry), sometimes referred to as a software stack, that an application developer can install on a virtual machine. The software stack provides a Platform-as-a-Service (PaaS) layer that contains functionality to support the developer's application. The PaaS layer can include functionality for testing, database integration, security management, health management, incremental updates, and auto scaling of the application.

A software component such as an application can run in a software container on a physical or virtual machine. While the virtual machine provides hardware virtualization, the software container provides operating system virtualization. See e.g., ww.informationweek.com/cloud/ptatform-as-a-service/docker-container-system-works-with-all-linuxes/d/d-id/1112830. The software container emulates an operating system environment having its own file system and namespace, for example. Thus, the software container can run as a process in an operating system environment of the virtual machine while providing another operating system environment inside the software container, assuming the second operating system uses the same kernel as the first one. An implementation of software containers is provided by the Docker project. The project provides a container engine that can instantiate software containers on a machine and take down software containers that are no longer needed.

Several configuration management tools, called “Puppet,” “Chef,” “Juju,” and

OpenStack Heat, allow an application developer (or administrator or other user) to write scripts that control the deployment of an application across multiple machines. Even with these tools, however, a developer still needs to separately determine how to deal with continuous deployment, package updates, health monitoring, virtual machine management, software dependency conflicts, and other issues in addressing a large-scale application deployment.

### SUMMARY

This disclosure relates to a container engine manager (CEM) that manages software containers and container engines within a computer system, such as a cloud computing environment. The CEM allows a user (e.g., an application developer, administrator, or end user) to manage the deployment of software containers. The user can treat the deployment as occurring on a single system being managed by the CEM, even when the software containers are actually deployed across multiple container engines. Thus, the user does not need to deal with keeping track of multiple machine IP addresses or directly configuring the machines on which the software containers are deployed. This abstraction further frees a developer or administrator from having to write scripts to configure the deployment across individual machines. In some implementations, the CEM not only operates between a user and an underlying container engine, but also provides the same application programming interface (API) as the container engine. This further simplifies a user's interaction with the CEM and allows the user to treat the software deployment as occurring on a single, meta container engine.

The CEM provides a simplified PaaS layer that offers a generic execution environment in which to deploy software containers. While other PaaS layers provided by Google App Engine, OpenShift, or CloudFoundry provide a software stack on which to develop an application, the developer is also limited by the limitations of the PaaS layer. For instance, CloudFoundry and OpenShift's PaaS layers only support stateless HTTP. An application that relies on managing state transition thus cannot rely on those PaaS layers.

While software containers allow a developer to build a more generic execution environment in which to develop an application, a container engine can run on only a single machine, and can thus deploy software containers only on the machine on which the container engine is running. To provide a host application that scales with user demand, the developer may still need to deal with multiple machines and configure the deployment of the application across multiple machines. Requiring this level of developer oversight increases the cost of application deployment.

The CEM thus provides a more automated and abstract layer that facilitates the deployment of applications. In some embodiments, it can perform load balancing or other scheduling techniques to manage application deployment across the underlying software containers and container engines. It further provides a more efficient way to avoid software dependency conflicts among applications, as discussed in more detail below.

According to an aspect of the disclosure, a method, system, and computer program product is provided for deploying software containers. In an embodiment, the container engine manager (CEM) instantiates a first container engine and instantiates a second container engine. The first container engine supports a first application program interface, API, the second container engine also supports the first API, and the CEM supports a second API that is compatible with the first API. The CEM determines that a first software container utilizing at least a first port number should be deployed. In response to determining that the first software container should be deployed, the CEM selects a container engine from a set of available container engines. The set of container engines comprises the first container engine and the second container engine. The CEM then causes the selected container engine to instantiate the first software container. The CEM associates the first port number with an IP address of the selected container engine.

In some embodiments, the CEM determines that the first software container should be deployed in response to receiving a software container deployment request message that instructs the CEM to deploy a software container. The software container deployment request message comprises a first set of port numbers and a first software container identifier identifying a first software container. The first set of port numbers includes the first port number.

In some embodiments, the method further comprises the CEM receiving a second software container deployment request message comprising a second set of one or more port numbers and a second software container identifier identifying a second software container. In such an embodiment, the method may further comprise the CEM determining whether each port number included in the second set of port numbers is currently being used by an existing software container; and in response to determining that none of the port numbers included in the second set of port numbers are currently being used by an existing software container, the CEM instantiating the second software container by transmitting an add software container message to one of the available container engines.

In some embodiments, the selected container engine executes within a virtual machine, and the method further comprises the CEM configuring one or more of a router (e.g., a virtual router) and an application proxy to forward to the virtual machine network layer packets that contain a transport layer header having said first port number contained in a destination port number field of the transport layer header. In such embodiments, the method may also include configuring the router to forward to the virtual machine network layer packets that contain a transport layer header having said port number contained in a destination port number field of the transport layer header; configuring the first container engine to use the router as its default gateway; and configuring the second container engine to use the router as its default gateway.

In some embodiments, the method further comprises: the CEM assigning a unique public process identifier to the software container. The method may also include the CEM obtaining a private process identifier assigned to the software container by the selected container engine. Further, the method may also include the CEM using a data structure to link the public process ID with the unique private process ID.

In some embodiments, the CEM is running on a first virtual machine and the selected container engine is instantiated on a second virtual machine.

In some embodiments, the software container hosts a process that provides a web real time communication (RTC) service or an IP multimedia (IMS) service.

In another aspect an apparatus is provided that is is adapted to instantiate a first container engine and a second container engine. The first container engine supports a first application program interface, API, the second container engine also supports the first API, and apparatus supports a second API that is compatible with the first API. The apparatus is further adapted to determine that a first software container utilizing at least a first port number should be deployed and select a container engine from a set of available container engines in response to determining that the first software container should be deployed. The set of container engines comprises the first container engine and the second container engine. The apparatus is further adapated to cause the selected container engine to instantiate the first software container. The apparatus is further adapted to associate the first port number with an IP address of the selected container engine.

The above and other aspects and embodiments are described in further detail below.

### BRIEF DESCRIPTION OF THE DRAWINGS

FIG. 1 illustrates a software container environment according to a first embodiment of the present disclosure.

FIG. 2 illustrates a software container environment according to a second embodiment of the present disclosure.

FIG. 3 illustrates a software container environment according to a third embodiment of the present disclosure.

FIG. 4 illustrates a software container environment according to a fourth embodiment of the present disclosure.

FIG. 5 is a message flow diagram illustrating an example message flow for instantiating a CEM.

FIG. 6 is flow chart illustrating a process according to some embodiments.

FIG. 7 is a flow chart illustrating a process according to some embodiments.

FIG. 8 is a message flow diagram illustrating an example message flow for instantiating a software container engine.

FIG. 9 is a message flow diagram illustrating an example message flow for registering an existing software container engine.

FIG. 10 is a message flow diagram illustrating an example message flow for starting a new software container.

FIG. 11 is flow chart illustrating a process according to some embodiments.

FIG. 12 illustrates an example process table.

FIG. 13 illustrates a machine according to one embodiment of the present disclosure.

### DETAILED DESCRIPTION

This disclosure relates to a container engine manager (CEM) that manages the deployment of software containers.

As used herein a “software container” is a software component that hosts other software components. Typically, a software container is implemented as an isolated user space instance. See http://en.wikipedia.org/wiki/Software_container. Such an isolated user-space instance may look and feel like a real server. Software containers are sometimes referred to as virtualization engines (VE), virtual private servers (VPS) or jails. A software container provides execution support to the software components it hosts in a way that is similar to an operating system hosting processes. See Sridhar, “A Behavioral Model For Software Containers,” FASE 2006, LNCS 3922, pp. 139-154, 2006. A software container can serve as a protective barrier, monitoring the interactions between hosted components and software components outside of the container, restricting the interactions to those that are deemed safe. Id.

A software container is deployed on a machine, such as directly on a developer's laptop (referred to as a “bare metal” deployment) or on a virtual machine provided by a data center. Data centers provided by Amazon EC2 or implementing OpenStack, for instance, provide an IaaS layer that can dynamically instantiate (e.g., boot) virtual machines allocated with processor, storage, and networking resources. As discussed above, certain projects provide a PaaS layer that provides a software stack having the operating system, libraries, and configuration to support an application, but have limitations that in turn limit the functionality of the application. In particular, many PaaS layers support only stateless HTTP, which does not support a Web Real Time Communication (WebRTC) or IP Multimedia Systems (IMS) host application.

While a developer can attempt to build a more generic execution environment, such environments present the potential for conflict among applications. For instance, the software dependencies among applications may be incompatible with each other. As an example, one application on a machine may require a Ruby 1.9.3 platform, while another application may require a Ruby 2.0.0 platform. If the machine cannot install both platforms, then the two applications generally cannot co-exist on the same machine. While the two applications can be installed on two different virtual machines, such resource usage may be inefficient.

A software container provides the generic execution environment in which to develop and deploy an application, but also isolates the application from other applications (or even from the rest of the machine's operating system environment). Thus, two applications can run in two different software containers. If the software containers are on the same machine, they run as two software processes that are isolated from each other. This sandbox-like isolation avoids the software dependency conflicts described above, and simplifies the deployment of multiple applications on the same machine. Deploying applications in different software containers is also more efficient than deploying them in different virtual machines. For example, while the software container may need to emulate an operating system environment with its own user space, file system, and memory, it may not need to emulate processing, storage, and networking resources. The software container may rely on the underlying machine for such resources. Thus, a software container image can be smaller than a virtual machine image and more efficient to deploy.

In an embodiment, the CEM deploys software containers provided by the Docker project. The Docker project provides a container engine (“Docker engine”) with an API that allows a user to dynamically deploy (e.g., instantiate) software containers (“Docker containers”) having a Linux Container (LXC) format. The Docker API is referred to as a representational state transfer (RESTful) HTTP API, which is discussed in more detail below. Each software container can provide a separate application namespace and file system that is isolated from those of other software containers. In an embodiment, a software container is implemented by packing the application as an image. The software container is deployed (e.g., instantiated) when the image is executed. In an embodiment, the software container includes the application image and a base image. The base image may include an operating system image and software libraries used to support the application.

While using container engines may avoid software dependency issues, the container engines can run on only a single machine. Thus, even though the user can command the container engine to deploy more software containers, the software containers cannot provide more resources than what is available on the machine. This limitation may require a developer to manually interact with multiple container engines to deploy an application on multiple machines, and thus increases the cost and complexity of the deployment.

A container engine manager improves the scalability and simplicity of such a deployment. The container engine manager (“CEM”) provides a layer of abstraction between a container engine and a user (e.g., an application developer, administrator, or end user). The user only needs to interact with the CEM to manage software containers, and does not need to directly interact with the underlying machines or container engines. In some instances, the CEM provides an API that is substantially identical to that of the underlying container engines. In such instances, a user who has written code that interacted with container engines may use the same code to interact with the CEM. In some instances, the user can treat the CEM as a software container environment having a single IP address (e.g., the IP address of the CEM), even if the underlying container engines have multiple, different IP addresses.

By having the ability to manage the deployment of software containers across multiple machines, the CEM can dynamically allocate more machines to a host application as user demand increases. Conversely, if the online application is experiencing a light load, the CEM can deploy the application's software containers on fewer machines.

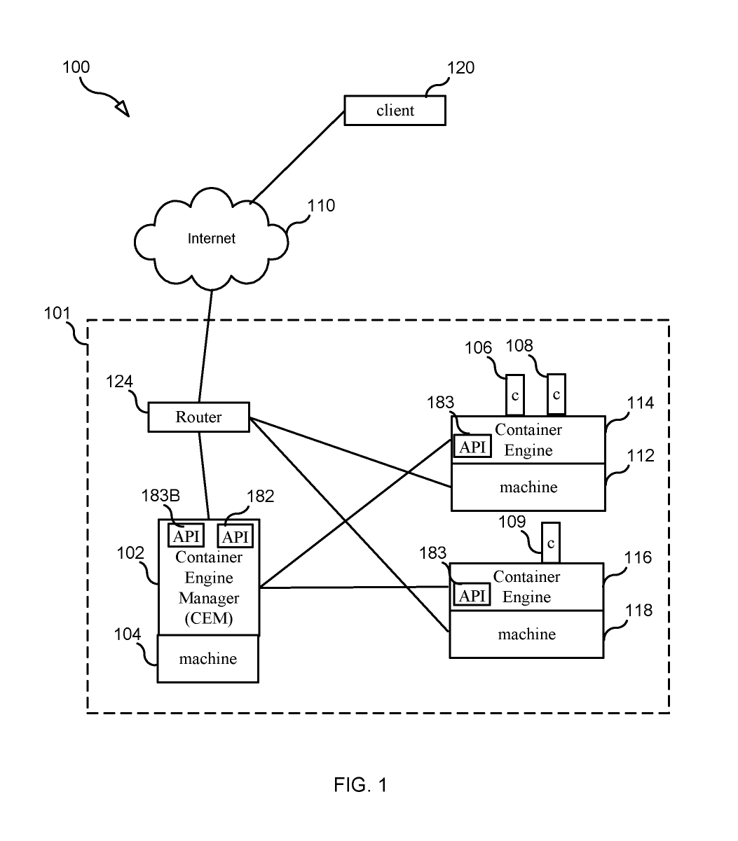

FIGS. 1-4 below illustrate a CEM managing a software container environment provided by a data center's IaaS layer. In other embodiments, however, the CEM can manage a container engine directly running on a developer's laptop, for example.

FIG. 1 illustrates a system 100 in which a container engine manager (CEM) 102 manages a software container environment 101 that a client 120 can access over a network 110 such as the Internet. In the software container environment 101, CEM 102 can manage software containers across multiple machines, which may be virtual machines, such as software containers 106 and 108 on machine 112 and software container 109 on machine 118. The software containers on each machine are managed by a container engine (e.g., container engines 114 and 116).

In one example, the software container environment 101 illustrated in FIG. 1 can provide web services such as a Web RTC service and an IMS service. CEM 102 can deploy a Web RTC host application on machine 112 and machine 118, inside software containers 106 and 109, respectively. CEM 102 can further deploy an IMS host application on machine 112, inside software container 108.

In an embodiment, CEM 102 deploys (e.g., instantiates) the software containers by communicating with the container engines 114, 118. The container engines 114, 118 support an API 183 that can be used to start and stop a process running in a software container. In an embodiment, CEM 102 supports API 183B, which, in some embodiments, is identical or substantially identical to API 183, or otherwise compatible with API 183. In some embodiments, APIs 183 and 183B are similar or identical to the Docker Remote API (see e.g., the web page located at docs.docker.io/en/latest/api/docker_remote_api/). For example, in some embodiments, APIs 183 and 183B are HTTP APIs that both support the following HTTP commands of the following form:

i) HTTP GET http://[cem|ce]/containers/:id/start; and

ii) HTTP GET http://[cem|ce]/containers/:id/stop.

The first command causes the CEM identified by the string “cem” (or the container engine identified by the string “ce”) to start the identified software container. Likewise, the second command causes the CEM identified by the string “cem” (or the container engine identified by the string “ce”) to stop the identified software container.

In addition to supporting API 183B, CEM 102 may also support a container engine API 182. The container engine API 182 defines commands that are presented as HTTP request messages, examples of which are listed below:

i) HTTP GET http://cem/ces (List all container engines attached to CEM 102)

ii) HTTP POST http://cem/ces (Register a container engine with CEM 102)
a. In an embodiment, if the container engine is already instantiated, the request needs to include access credentials such as Secure Shell (SSH) keys or Docker keys so that CEM 102 can access the container engine.
b. In the embodiment, if the container engine is not instantiated, CEM 102 can request the IaaS layer to instantiate a new virtual machine and to instantiate a container engine on that virtual machine.

iii) HTTP GET http://cem/ce/:id (Get information on a container engine with a particular ID registered with CEM 102)

iv) HTTP PUT http://cem/ce/:id (Update information on a container engine with a particular ID)

v) HTTP delete http://cem/ce/:id (Unregister a container engine with a particular ID)

In an embodiment, software containers 106, 108, and 109 are Docker software containers, while container engines 114 and 116 are Docker engines.

Referring to the above example, network traffic to the Web RTC host application or the IMS host application can be routed to the appropriate software container through a router 124, which may be a virtual router. The routing can be based on port numbers, which is discussed in more detail below. Further, the machines 104, 112, and 118 can be physical machines or virtual machines.

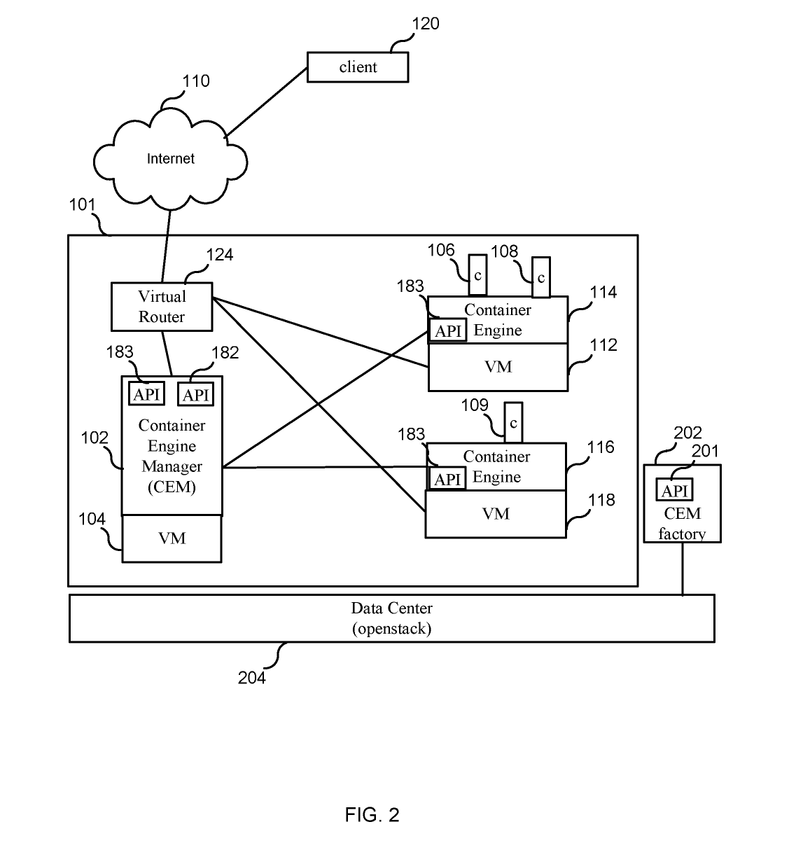

FIG. 2 illustrates an environment in which virtual machines 104, 112, and 118 are provided through a data center 204 that provides an IaaS system, such as Amazon EC2 or OpenStack system. Data center 204 allows CEM 102 to request new virtual machines to be instantiated (e.g., booted) on demand. Each virtual machine may be allocated a certain amount of processing, storage, networking, or other resources. As user demand on an application increases, CEM 102 can request OpenStack to instantiate new virtual machines on which to deploy software containers.

In an embodiment, the router 124 in the software container environment 101 is a virtual router that is part of the OpenStack IaaS system (referred to as a Neutron router). CEM 102 can configure the router 124 to ensure that network traffic is routed to the appropriate software container.

In an embodiment, CEM 102 may be instantiated by a CEM factory 202. CEM factory 202 provides an API 201 that allows a user (e.g., an application administrator) to create new instances of CEM 102's, or to stop a CEM 102 from running. In some implementations, API 201 is a RESTful HTTP API that interfaces with users. As an example, the API 201 includes the following commands:

i) HTTP GET http://factory/cems (Return URL's and access credentials of all instantiated CEM 102's)

ii) HTTP POST http://factory/cems (Create a new CEM 102 with no registered container engines)

iii) HTTP GET http://factory/cems/:id (Get information about a CEM 102 with a particular ID)

iv) HTTP PUT http://factory/cems/:id (Update information on a particular CEM 102 with a particular ID)

v) HTTP DELE IE http://factory/cems/:id (Delete CEM 102 with a particular ID and unregister and/or delete all associated container engines)

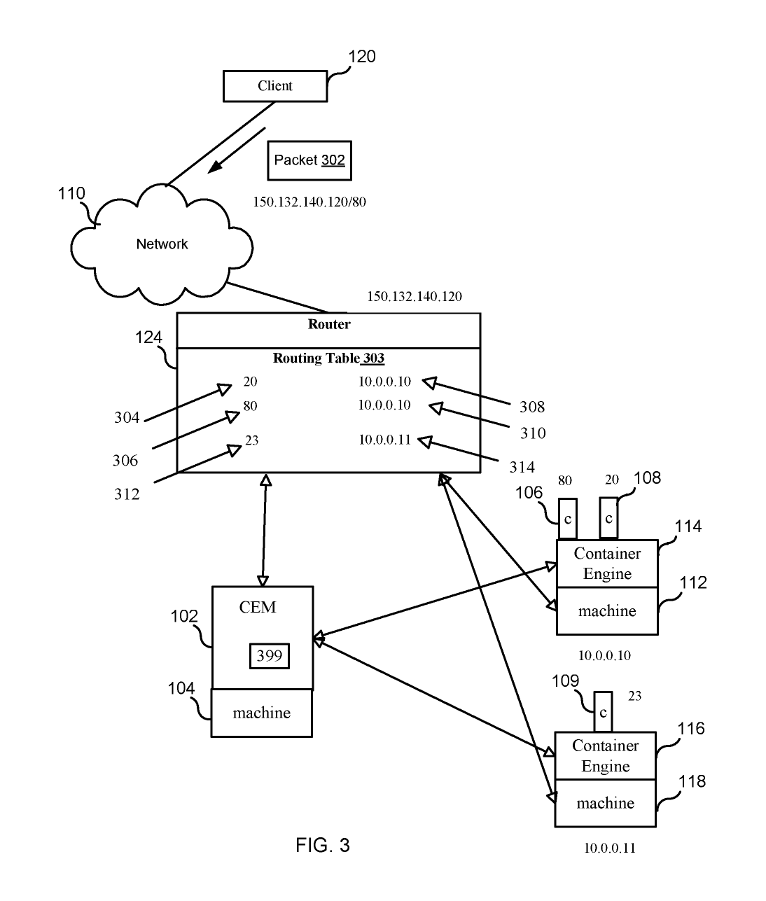

FIG. 3 illustrates an embodiment in which a single IP address can act as a public IP address of the entire software container environment 101. This provides a layer of abstraction that allows users to treat various applications as being deployed on a single device. A user can thus access or manage various applications through a single IP address. As shown in FIG. 3, a client uses a single IP address (e.g., 150.132.140.120) to communicate with applications deployed in software containers of the software container environment 101, even when the underlying software containers run on machines having different IP addresses (e.g., 10.0.0.10 and 10.0.0.11). Such an implementation may conserve the use of public IP addresses by being able to allocate private IP addresses to the underlying machines while allocating only a single public IP address to CEM 102.

In the illustrated environment, router 124 includes a routing table 303 that routes network traffic from a public IP address used by the client 120 and a private IP address of the underlying software container. CEM 102 may configure the routing table 303 to facilitate the correct routing. As the figure shows, CEM 102 may provide an abstraction that the software containers are running on different ports of a single machine. Thus, an end user may access various host applications with different port numbers of a single IP address. CEM 102 meanwhile facilitates the routing of traffic to the actual underlying machine. The routing is discussed in more detail below.

FIG. 3 further illustrates a process table (PT) 399 stored in CEM 102. As discussed above, software containers may be treated as software processes running in a machine's operating system environment. The PT 399 allows CEM 102 to assign a public process ID to each deployed software container. The PT 399 maps the public process ID to a private process ID generated by the underlying container engine. In situations where two underlying container engines coincidentally generate the same process ID for two software containers, the PT 399 can map them to two different public process ID's. The mapping and the PT 399 is described in more detail below.

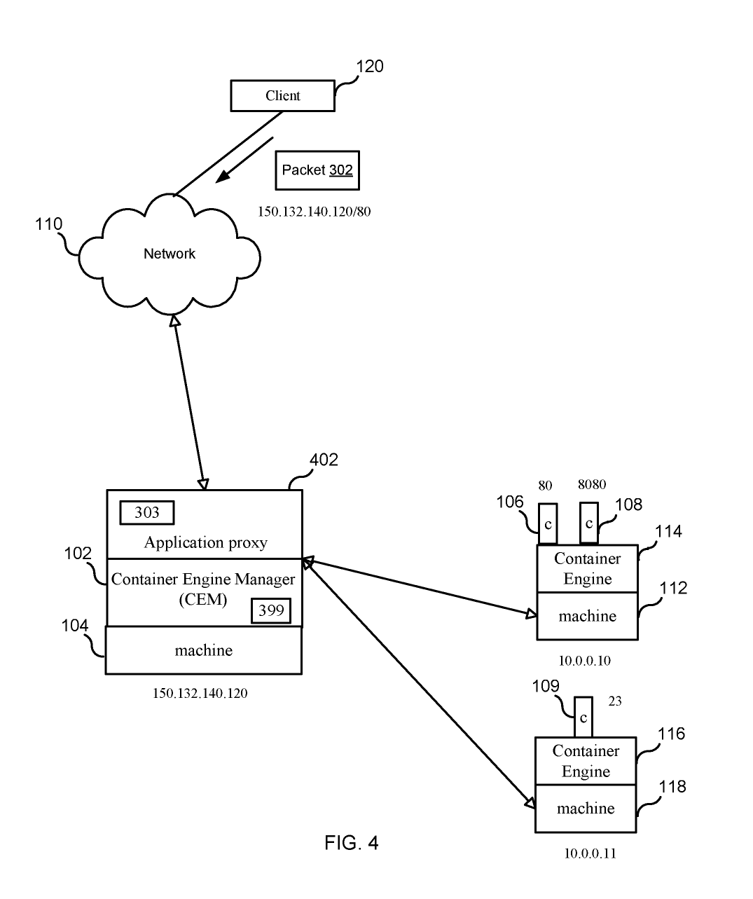

FIG. 4 illustrates an alternative embodiment where an application proxy 402 is used instead of router 124. In this case, application proxy 402, which is provided by CEM 102, is responsible for creating a new connection and redirecting the traffic to a software container running in a container engine 114, 116. An example of an application proxy could for example be an NginX web server that redirects all HTTP traffic to a container engine 114, 116. In this embodiment, the application proxy 402 itself stores the routing table 303. The application proxy 402 receives incoming network traffic and routes the incoming network traffic to the appropriate software container using the routing table 303.

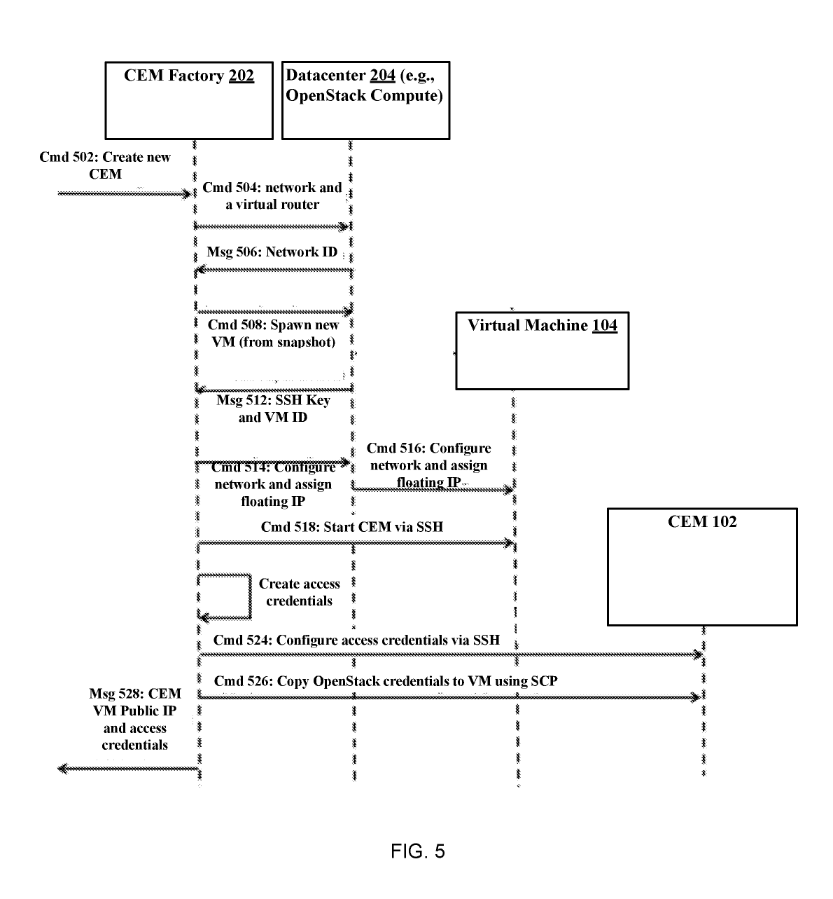

FIG. 5 is a message flow diagram illustrating an example message flow for instantiating CEM 102. As FIG. 5 shows, CEM 102 can be instantiated by CEM factory 202, which receives a command message 502 to create a new CEM. The command message may have been generated manually (e.g., by an application administrator) or automatically (e.g., by a script).

In response to command message 502, CEM factory 202 sends a command message 504 to data center 204 instructing the data center to 204 create a network for CEM 102 and to create a virtual router 124 (e.g., a Neutron Router in the case that data center 204 is an OpenStack data center). All container engines that are created by CEM 102 will be connected to the network and use virtual router 124 as its default gateway. Because the virtual router 124 is connected to a public network (it has a floating IP) it is possible to add port-forwarding rules to the virtual router 124, as discussed above, so that all incoming traffic on a specific transport layer port is redirected to a specific container engine. In this way, it looks like all traffic originates from CEM 102.

In response, data center 204 can return a message 506 containing a network ID identifying the network. CEM factory 202 then sends to data center 204 a command message 508 that instructs the data center to instantiate a new virtual machine. Data center 204 then instantiates a new virtual machine, such as virtual machine 104. CEM factory 202 and the virtual machine 104 can communicate over a network via an SSH encryption key and virtual machine (VM) ID, which are returned to the factory 202 in message 512.

After the new virtual machine is created, CEM factory 202 sends to the data center a command message 514 to configure network settings and assign an IP address to the virtual machine 104 that will host CEM 102. In an embodiment, CEM factory 202 assigns a public IP address to CEM 102. Data center 204 receives the configuration and assigned IP address, and communicates a command message 516 to the virtual machine 104 with the same settings.

After the virtual machine 104 has been instantiated, CEM factory 202 can communicate a command message 518 via SSH to the virtual machine to start a CEM 102. The virtual machine 104 receives the command message and starts CEM 102. To allow users to access CEM 102, CEM factory 202 further configures access credentials via SSH with a command message 524 and instructs CEM 102 to copy the data center credentials to the virtual machine 104 using SCP with command message 526. CEM factory 202 can then return a message 528 to the user that identifies the virtual machine 104's public IP address and access credentials

After CEM factory 202 has instantiated CEM 102, CEM 102 can manage software containers and container engines (or even just a single container engine). CEM 102 can attach (e.g., register) existing (i.e., instantiated) container engines or new container engines that have been instantiated at the request of CEM 102.

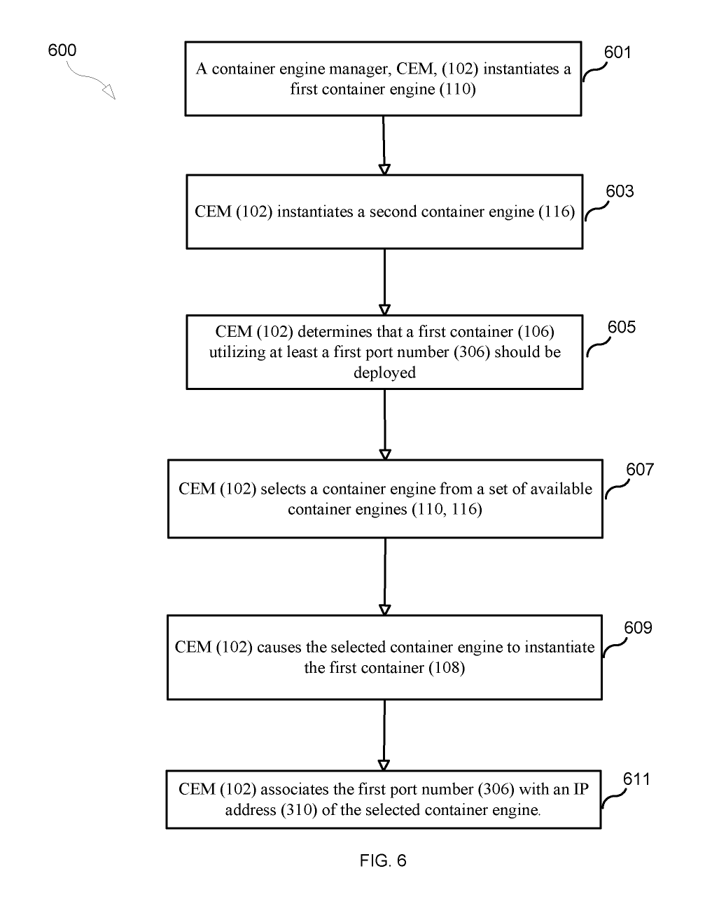

FIG. 6 is a flow chart illustrating a process 600 for deploying a software container. As discussed above, CEM 102 provides a layer of abstraction that allows a user to treat multiple software containers in a software container environment as if they were deployed on a single machine, even when they are deployed across multiple machines.

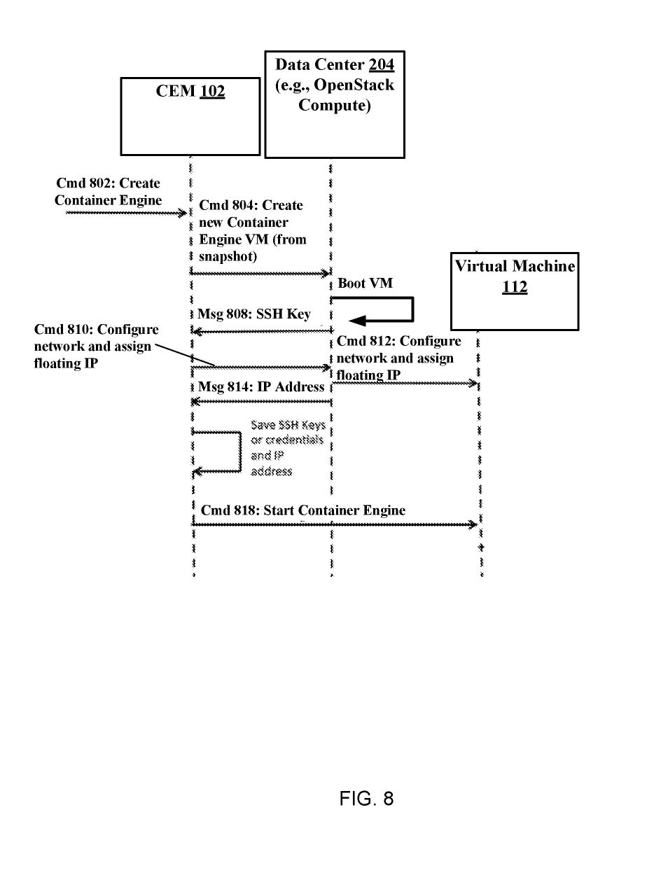

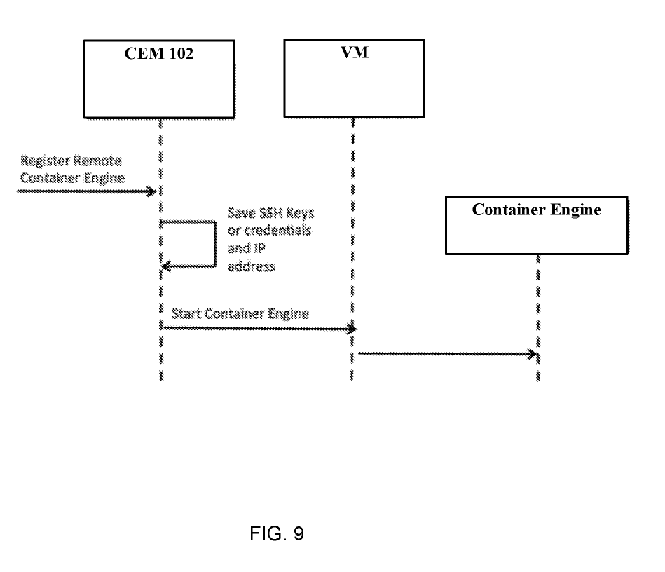

In an embodiment, process 600 begins at step 601, in which CEM 102 instantiates (e.g., creates or registers) a first container engine (e.g., container engine 114). The first container engine may run directly on a physical machine, or may run on a virtual machine. In some instances, CEM 102 may first create a virtual machine that will then host the first container engine. As an example, CEM 102 may send a command message to data center 204 to instruct data center 204 system to boot a new virtual machine. After the virtual machine is booted, CEM 102 issues a command message to the virtual machine to create a container engine (see e.g., FIG. 8, cmd 818; and FIG. 9, cmd 906).

In step 603, CEM 102 instantiates a second container engine (e.g., container engine 116). In some instances, CEM 102 may instantiate the second container engine to dynamically allocate more resources to an application as usage load increases. Like in step 601, CEM 102 may first cause data center 204 to boot a virtual machine that will then host the second container engine.

In step 605, CEM 102 determines that a first software container (e.g., software container 106) utilizing at least a first port number (e.g., a set of one or more port numbers, such as 306 and 8080) should be deployed. For instance, CEM 102 may determine that an additional software container should be deployed to run an application that hosts a Web RTC service. In some cases, the software container is deployed when it is instantiated and ready to execute application code. In an embodiment, CEM 102 may assign a port number (e.g., 80) to the first software container, provided the port number is not occupied by another deployed software container.

In step 607, CEM 102 selects a container engine from a set of available container engines (e.g., container engines 114, 116). In an embodiment, the selection may be based on a scheduling algorithm. As one example, the scheduling algorithm may select container engines in a round robin style. As another example, the scheduling algorithm may perform load balancing among the container engines. For instance, CEM 102 may attempt to deploy an equal number of software containers with each container engine, or may attempt to keep CPU or memory load equal among the container engines.

In step 609, CEM 102 causes the selected container engine to instantiate the first software container. In instances where the software container executes an application, CEM 102 may provide arguments (e.g., parameters) in its command message to instantiate the first software container.

In step 611, CEM 102 associates the first port number with an IP address of the selected container engine. The association facilitates port forwarding of network traffic to the appropriate software container. As discussed above, CEM 102 may provide an abstraction layer in which users deal with a single IP address in accessing multiple software containers. In such cases, each software container may be addressed by a port number of the IP address. Thus, if the first software container were software container 106, it may be addressed by, e.g., port 80. CEM 102 may associate the port number with the IP address, e.g. 10.0.0.10, of the container engine 114 on which the software container 106 is deployed. In some instances, CEM 102 causes the association to be stored in a routing table (e.g., routing table 303) that is used to route network traffic to the software containers.

When end-users later access a host application, the routing table routes network traffic from a port number in the end users' network traffic to the appropriate IP address (e.g., from port 80 to IP address 10.0.0.10). At the IP address, the virtual machine passes the network traffic to the container engine, which uses the port number to route the traffic to the appropriate software container.

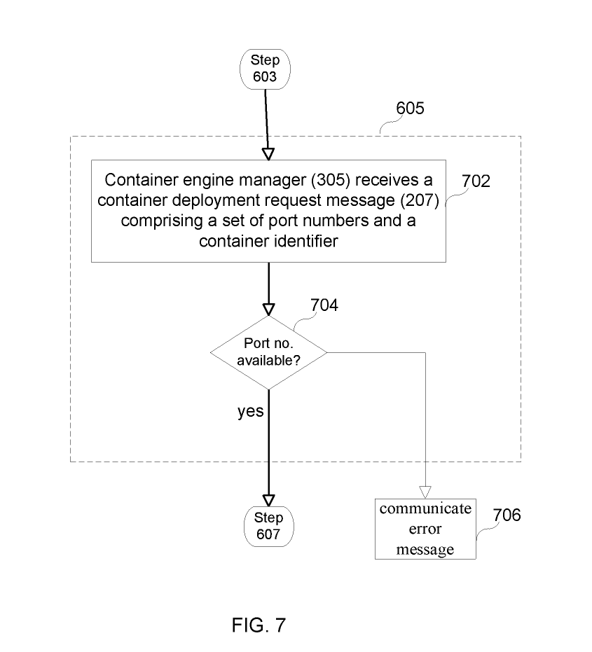

FIG. 7 illustrates steps that may comprise step 605 of process 600. CEM 102 in the example relies on port numbers to address individual software containers, and thus determines whether any attempt to deploy the software containers would create a conflict. In an embodiment, step 605 includes step 702, in which CEM 102 receives a software container deployment request message that comprises a port number and a software container identifier. For instance, an application administrator may request that CEM 102 deploy a software container on port 80. In step 704, CEM 102 determines whether the port number is available. In response to determining that the port number is available, CEM 102 proceeds to step 607 to select a container engine that will host the software container. In response to determining that the port number is not available, however, CEM 102 communicates an error message in step 706. In some instances, the entity that communicated the software container deployment request may send a new request with a different port number.

FIG. 8 is a message flow diagram illustrating steps that may be performed to instantiate a new container engine. As illustrated in FIG. 8, CEM 102 may receive a command message 802 that causes CEM 102 to perform steps for instantiating a new container engine. In some cases, command message 802 expressly instructs CEM 102 to create a new container engine, while in some other cases, command message 802 instructs CEM 102 to instantiate a new software container, which, in response, may determine that the requested software container should be deployed on a new container engine. In either case, to instantiate a new container engine, CEM 102 sends to data center 204 a command message 804 that instructs data center to create a virtual machine on which the container engine will be hosted. In cases where data center 204 is an OpenStack data center, CEM 102 uses the OpenStack API to create a new virtual machine.

In response to command message 804, data center 204 boots a new virtual machine (VM) (e.g., VM 112). After data center (e.g. OpenStack) 204 boots the VM, data center 204 sends to CEM a message 808 that includes an encryption key (e.g., an SSH encryption key). Next, CEM 102 sends to data center 204 a command message 808 that instructs data center 204 to connect the VM to the CEM 102′s network (i.e., the network created by data center 204 in response to command message 504 from CEM factory 202) and to configure the VM such that the VM will use as its default gateway the virtual router created for CEM 102 (i.e., the virtual router created by data center 204 in response to command message 504 from CEM factory 202). In response to command message 810, data center 204 send to the VM a network configuration command message 812, which assigns an IP address to the VM and configures the VM to use the virtual router as its default gateway. Data center 204 then sends to CEM 102 a message 814 that includes the IP address assigned to the VM.

After the VM is instantiated, CEM 102 may issue to the virtual machine a command message 818 that instructs the virtual machine to instantiate (e.g., start) a container engine (e.g., CE 114).

In addition to adding a container engine to software container environment 101, it is also possible to add to software container environment 101 an existing container engine. In this case, a developer (or a software component) provides to CEM 102 a credential (e.g., an SSH key) and the IP address of the existing container engine. This alternative procedure is illustrated in the message flow diagram shown in FIG. 9.

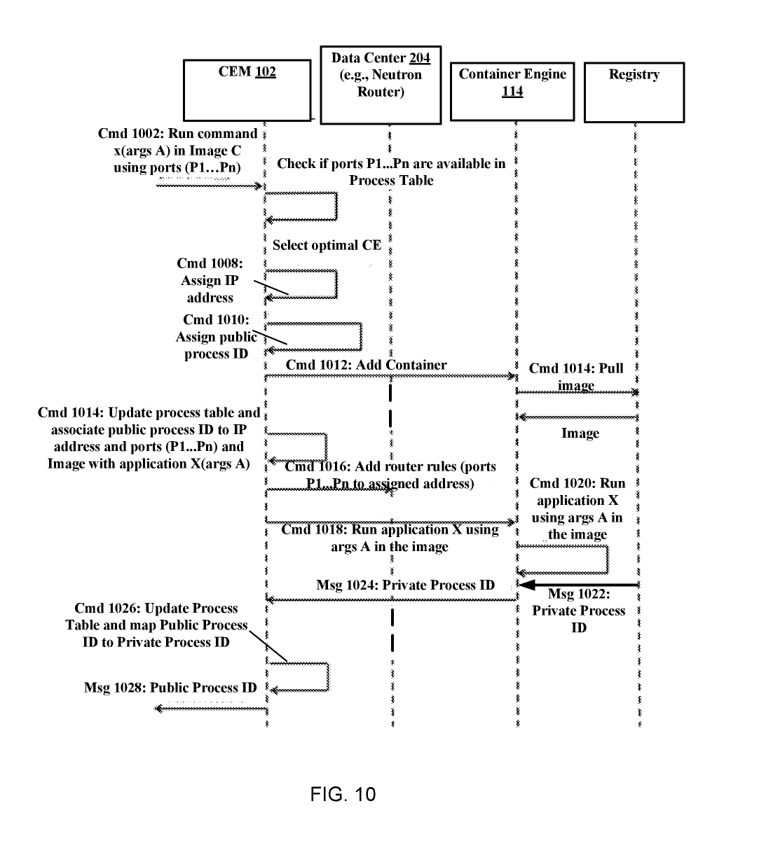

FIG. 10 is a message flow diagram illustrating steps involved in spawning a new software container. In the example, a user issues to CEM 102 a command message 1002 that instructs CEM 102 to deploy a software container to run a command (“command x”), along with a set of arguments (e.g., parameters) for the command. The command message 1002 may be generated manually by the user, or through a script or other automated tool written by the user. The command message 1002 may include a software container identifier identifying a software container (e.g., identifying an image for the software container) and one or more port numbers (e.g., 21, 23, and 80) to be used by the software container. Command message 1002 may be referred to as a “software container deployment request message” 1002

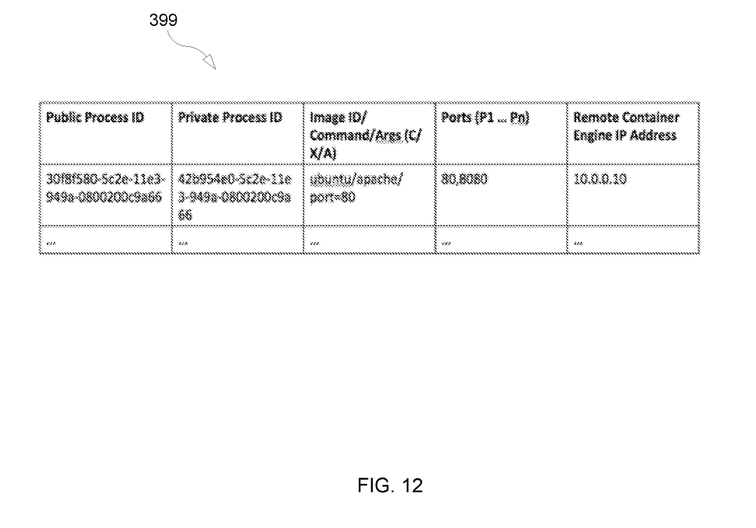

If CEM 102 determines that the port numbers are available, CEM 102 then selects an optimal container engine on which to deploy the software container. As discussed above, CEM 102 may select a container engine based on a load balancing algorithm. Additionally, CEM 102 may perform the step of determining whether the port numbers are available by searching a process table 401 to determine whether the port numbers are currently allocated to another software container. An example process table 401 is illustrated in FIG. 12.

CEM 102 then assigns a public process ID for the software container. If the container engine does not have an IP address (e.g., if it is being instantiated for the first time), CEM 102 can assign an IP address to the container engine. CEM 102 then issues a command message 1012 to the container engine to instruct it to add the software container. CEM 102 may further update the process table 401 and associate the public process ID to the assigned IP address and port numbers. In some cases, CEM 102 further associates the public process ID with the image, command, and the arguments to the application command. In an embodiment, CEM 102 may update the associations in a router.

In the example, the software containers may be created from images that are stored in a registry. The registry may store, for example, an image for a Web RTC host application or for an IMS host application. In some cases, the command message 1002 from the user may identify the software container image. The container engine 114 can then issue a command message 1014 to retrieve the image from the registry. CEM 102 may then issue a command message 1018 with the command and arguments. When the command is run, a private process ID for the process that is invoked by the running of the command may be received and returned to CEM 102. CEM 102 may update the process table 401 to map the public process ID to the private process ID. For instance, FIG. 12 shows an example process table 401 that maps the public process ID to the private process ID. As discussed above, the private process ID's may be generated by the container engine. The mapping allows CEM 102 to return a unique public process ID for a software container even when the container engine generates a private process ID that coincides with the private process ID generated by another container engine.

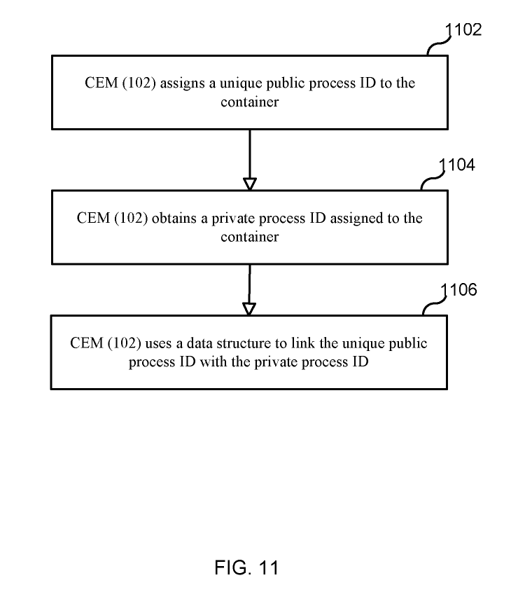

FIG. 11 provides a flow diagram that illustrates the association of the public process ID with the private process ID. More particularly, in step 1102, CEM 102 assigns a unique public process ID to a software container that is going to be instantiated. In step 1104,

CEM 102 obtains a private process ID assigned to the software container, such as through the message 1022 in FIG. 10. The private process ID may be obtained from the container engine on which the software container is running. In step 1106, CEM 102 uses a data structure, such as the process table 401 in FIG. 12, to link the unique public process ID with the private process ID.

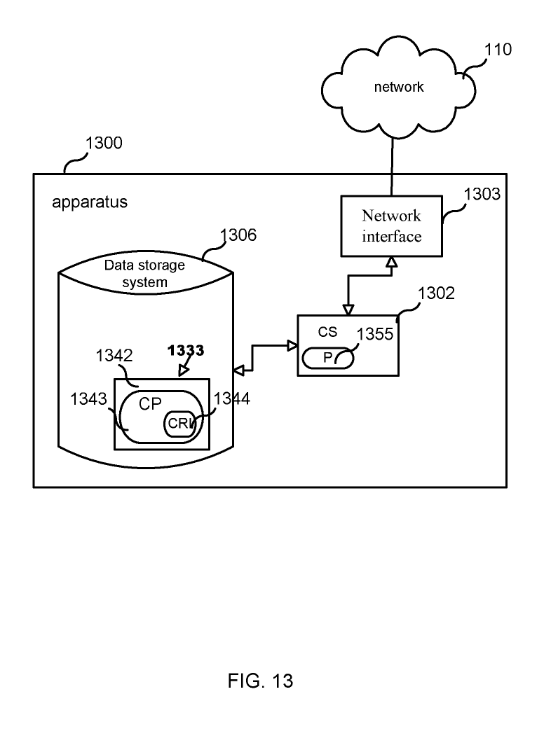

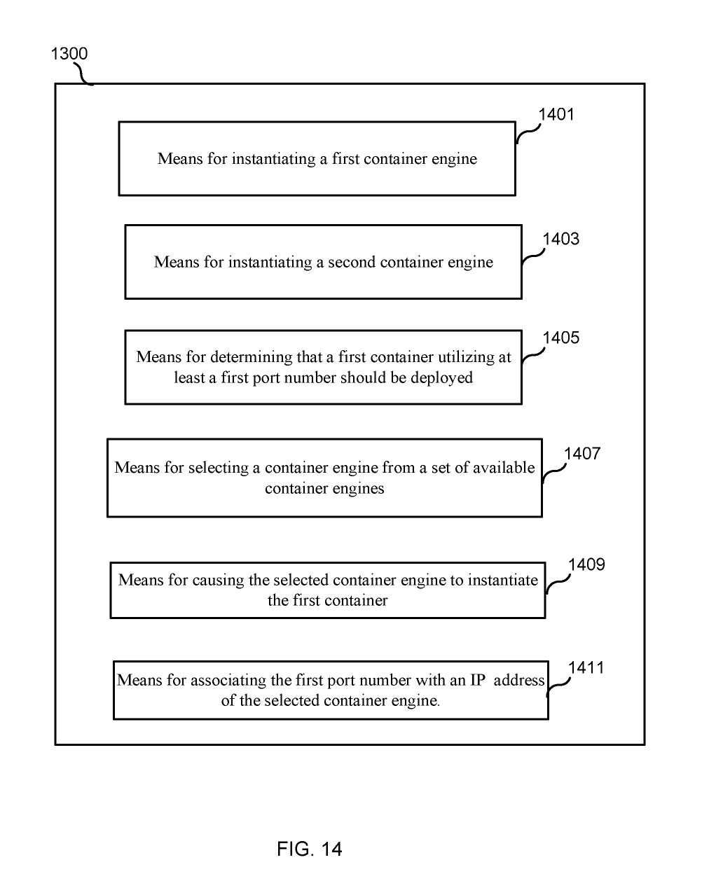

FIG. 13 is a block diagram of an embodiment of an apparatus 1300 for implementing the components described above. As shown in FIG. 13, apparatus 1300 may include or consist of: a computer system (CS) 1302, which may include one or more processors 1355 (e.g., a general purpose microprocessor) and/or one or more circuits, such as an application specific integrated circuit (ASIC), field-programmable gate arrays (FPGAs), a logic circuit, and the like; a network interface 1303 for use in connecting apparatus 1300 to network 110; and a data storage system 1306, which may include one or more non-volatile storage devices and/or one or more volatile storage devices (e.g., random access memory (RAM)). In embodiments where apparatus 1300 includes a processor 1355, a computer program product (CPP) 1333 may be provided. CPP 1333 includes or is a computer readable medium (CRM) 1342 storing a computer program (CP) 1343 comprising computer readable instructions (CRI) 1344. CRM 1342 may include a non-transitory computer readable medium, such as, but not limited, to magnetic media (e.g., a hard disk), optical media (e.g., a DVD), solid state devices (e.g., random access memory (RAM), flash memory), and the like. In some embodiments, the CRI 1344 of computer program 1343 is configured such that when executed by computer system 1302, the CRI causes the apparatus 1300 to perform steps described above (e.g., steps described above with reference to the flow charts and message flows shown in the drawings). In other embodiments, apparatus 1300 may be configured to perform steps described herein without the need for a computer program. That is, for example, computer system 1302 may consist merely of one or more ASICs. Hence, the features of the embodiments described herein may be implemented in hardware and/or software.

FIG. 14 is a functional block diagram of apparatus 1300 according to some embodiments. In the embodiment shown, apparatus 1300 comprises: means 1401 for instantiating a first container engine 114; means 1403 for instantiating a second container engine 116; means 1405 for determining that a first software container 106 utilizing at least a first port number should be deployed; means 1407 for selecting a container engine 114 from a set of available container engines 114, 116; means 1409 for causing the selected container engine 114 to instantiate the first software container 108; and means 1411 for associating the first port number with an IP address of the selected container engine 114.

While various aspects and embodiments of the present disclosure have been described above, it should be understood that they have been presented by way of example only, and not limitation. Thus, the breadth and scope of the present disclosure should not be limited by any of the above-described exemplary embodiments. Moreover, any combination of the elements described in this disclosure in all possible variations thereof is encompassed by the disclosure unless otherwise indicated herein or otherwise clearly contradicted by context.

Additionally, while the processes described herein and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for deploying and managing software containers, comprising:
a container engine manager (CEM) instantiating a first container engine;
the instantiating a second container engine, wherein the first container engine supports a first application program interface (API), the second container engine also supports the first API, and the CEM supports a second API that is compatible with the first API;
the CEM determining that a first software container utilizing at least a first port number should be deployed;
in response to determining that the first software container should be deployed, the CEM selecting a container engine from a set of available container engines, the set of container engines comprising the first container engine and the second container engine;
the causing the selected container engine to instantiate the first software container; and
the CEM associating the first port number with an IP address of the selected container engine.

2. The method of claim 1, wherein the CEM determines that the first software container should be deployed in response to receiving a software container deployment request message that instructs the CEM to deploy a software container, the software container deployment request message comprising a first set of port numbers, which first set of port numbers includes the first port number, and a first software container identifier identifying a first software container.

3. The method of claim 2, further comprising:
the CEM receiving a second software container deployment request message comprising a second set of one or more port numbers and a second software container identifier identifying a second software container;
the CEM determining whether each port number included in the second set of port numbers is currently being used by an existing software container; and
in response to determining that none of the port numbers included in the second set of port numbers are currently being used by an existing software container, the CEM instantiating the second software container by transmitting an add software container message to one of the available container engines.

4. The method of claim 1, wherein
the selected container engine executes within a virtual machine, and
the method further comprises the CEM configuring one or more of a router and an application proxy to forward to the virtual machine network layer packets that contain a transport layer header having said first port number contained in a destination port number field of the transport layer header.

5. The method of claim 4, further comprising:
configuring the router to forward to the virtual machine network layer packets that contain a transport layer header having said port number contained in a destination port number field of the transport layer header;
configuring the first container engine to use the router as its default gateway; and
configuring the second container engine to use the router as its default gateway.

6. The method of claim 5, wherein the router is a virtual router.

7. The method of claim 1, further comprising:
the CEM assigning a unique public process identifier to the software container;
the CEM obtaining a private process identifier assigned to the software container by the selected container engine;
the CEM using a data structure to link the public process ID with the unique private process ID.

8. The method of claim 1, wherein the CEM is running on a first virtual machine and the selected container engine is instantiated on a second virtual machine.

9. The method of claim 1, wherein the software container hosts a process that provides a web real time communication service or an IP multimedia service.

10. An apparatus adapted to:
instantiate a first container engine;
instantiate a second container engine), wherein the first container engine supports a first application program interface, API, the second container engine also supports the first API, and the CEM supports a second API that is compatible with the first API;
determine that a first software container utilizing at least a first port number should be deployed;
select a container engine from a set of available container engines in response to determining that the first software container should be deployed, the set of container engines comprising the first container engine and the second container engine;
cause the selected container engine to instantiate the first software container; and
associate the first port number with an IF address of the selected container engine.

11. A computer program product comprising a non-transitory computer readable medium comprising instructions which, when executed on at least one processor, cause the at least one processor to carry out the method of claim 1.

12. An apparatus comprising:
means for instantiating a first container engine;
means for instantiating a second container engine, wherein the first container engine supports a first application program interface, API, the second container engine also supports the first API, and the CEM supports a second API that is compatible with the first API;
means for determining that a first software container utilizing at least a first port number should be deployed;
means selecting a container engine from a set of available container engines in response to a determination that the first software container, should be deployed, the set of container engines comprising the first container engine and the second container engine;
means for causing the selected container engine to instantiate the first software container; and
means for associating the first port number with an IF address of the selected container engine.

13. (canceled)
